(19) United States
(12) Patent Application Publication
(10) Pub. No.: US 2020/0080756 A1
(43) Pub. Date: Mar. 12, 2020

(54) REFRIGERATION MACHINE

(71) Applicant: MITSUBISHI HEAVY INDUSTRIES THERMAL SYSTEMS, LTD., Tokyo (JP)

(72) Inventors: Hirotaka Tanimura, Tokyo (JP); Noriyuki Matsukura, Tokyo (JP)

(73) Assignee: MITSUBISHI HEAVY INDUSTRIES THERMAL SYSTEMS, LTD., Tokyo (JP)

(21) Appl. No.: 16/498,281

(22) PCT Filed: Mar. 5, 2018
(86) PCT No.: PCT/JP2018/008203

§ 371 Date: Sep. 26, 2019

(30) Foreign Application Priority Data
Mar. 29, 2017 (JP) 2017-064885

(51) Int. Cl. F25B 41/06; F25B 31/00; F16C 37/00

(52) U.S. Cl. CPC F25B 41/062; F16C 37/007; F25B 31/004

(57) ABSTRACT

The purpose of the present invention is to provide a refrigeration machine wherein lubricating oil supplied to a bearing, etc. in a turbo compressor is capable of being cooled by a simple configuration. This refrigeration machine (1) comprises: a refrigeration cycle in which a refrigerant circulates, the refrigeration cycle being provided with a turbo compressor (2) having a compression mechanism driven by a motor, the refrigeration cycle being further provided with a condenser (3) and an evaporator (8); an oil tank (23) in which lubricating oil is stored; a lubricating oil supply line (22) for supplying lubricating oil from the oil tank (23) into a motor housing (31) containing the motor; and a liquid refrigerant supply line (24) for supplying a refrigerant from the condenser (3) into the motor housing (31).

### TECHNICAL FIELD

The present invention relates to a chiller.

### BACKGROUND ART

A turbo compressor installed in a centrifugal chiller is configured to include a compression mechanism and a speed-increasing mechanism. In order to stably operate the turbo compressor, it is necessary to properly and continuously supply a lubricant to a bearing for supporting an impeller of the compression mechanism, or a gear of the speed-increasing mechanism. A lubricant supply system includes an oil tank and an oil pump, and a lubricant stored in the oil tank is supplied to the bearing or the gear of the turbo compressor by the oil pump. The lubricant supplied to the bearing or the gear returns to the oil tank, and repeatedly circulates through a lubricant supply system.

A temperature of the lubricant supplied to the bearing or the gear is raised due to heat generation resulting from mechanical loss. Accordingly, an oil cooler is generally installed in the lubricant supply system. The oil cooler cools the lubricant, and the cooled lubricant is supplied to the bearing or the gear.

### CITATION LIST

### Patent Literature

[PTL 1] Japanese Examined Utility Model Registration Application Publication No. 60-2535

[PTL 2] Japanese Unexamined Patent Application Publication No. 2014-190616

[PTL 3] Japanese Unexamined Patent Application Publication No. 2015-194300

### SUMMARY OF INVENTION

### Technical Problem

For example, the oil cooler installed in the above-described lubricant supply system is a plate type heat exchanger. In the oil cooler, heat is exchanged between the lubricant and a refrigerant flowing through a refrigeration cycle of the centrifugal chiller, thereby cooling the lubricant. The refrigerant supplied to the oil cooler is a liquid refrigerant extracted from a condenser or a sub-cooler disposed in the refrigeration cycle. The liquid refrigerant passes through an expansion valve, and is supplied to the oil cooler after the temperature of the liquid refrigerant is lowered. The refrigerant subjected to heat exchange with the lubricant in the oil cooler is brought into a gas-liquid two-phase state, and is supplied to an evaporator of the refrigeration cycle.

According to the lubricant supply system configured in this way, in order to cool the lubricant, it is necessary to install the oil cooler or to install the expansion valve between the condenser or the sub-cooler and the oil cooler. Consequently, a configuration of the centrifugal chiller is complicated, and the cost increases due to equipment installation.

The present invention is made in view of the above-described circumstances, and an object thereof is to provide a chiller having a simple configuration capable of cooling a lubricant to be supplied to a bearing of a turbo compressor.

### Solution to Problem

According to an aspect of the present invention, there is provided a chiller including a refrigeration cycle that includes an electric compressor having a compression mechanism driven by a motor, a condenser, and an evaporator, and that allows a refrigerant to circulate therethrough, an oil tank that stores a lubricant, an oil supply pipe that supplies the lubricant from the oil tank into a first housing which houses the motor, and a refrigerant supply pipe that supplies the refrigerant from the condenser into the first housing.

According to this configuration, the motor for driving the compression mechanism is housed in the first housing, and the lubricant is supplied from the oil tank to the first housing. Accordingly, the lubricant can lubricate a bearing for supporting the motor. In addition, the refrigerant is supplied from the condenser into the first housing. Accordingly, the lubricant having a raised temperature can be cooled by lubricating the bearing.

In the aspect, the electric compressor may further have a speed-increasing mechanism coupled with the motor and the compression mechanism. The refrigerant and the lubricant may flow from the first housing, and may flow from the oil tank into a second housing which houses the speed-increasing mechanism.

According to this configuration, the speed-increasing mechanism coupled with the motor and the compression mechanism are housed in the second housing. The lubricant flows from the first housing to the second housing. In this manner, the lubricant can lubricate a gear configuring the speed-increasing mechanism.

In the aspect, the electric compressor may further have a speed-increasing mechanism coupled with the motor and the compression mechanism. The oil supply pipe may supply the lubricant from the oil tank into a second housing which houses the speed-increasing mechanism.

According to this configuration, the speed-increasing mechanism coupled with the motor and the compression mechanism are housed in the second housing. The lubricant is supplied from the oil tank to the second housing. In this manner, the lubricant can lubricate the gear configuring the speed-increasing mechanism.

In the aspect, the refrigeration cycle may further include a sub-cooler. The refrigerant supply pipe may supply the refrigerant from the sub-cooler into the first housing.

According to this configuration, the refrigerant is supplied from the sub-cooler into the first housing. Accordingly, the lubricant having the raised temperature can be cooled by lubricating the bearing.

In the aspect, the chiller may further include a discharge pipe that discharges the lubricant and the refrigerant from the first housing to the oil tank, and a heater that is disposed inside the discharge pipe located inside the oil tank.

According to this configuration, the lubricant and the refrigerant are discharged from the first housing to the oil tank via the discharge pipe. The discharge pipe is also located inside the oil tank. The heater is installed in the discharge pipe located inside the oil tank. The temperature of the heater is raised. In this manner, the lubricant and the refrigerant are heated, and the refrigerant evaporates. As a result, kinematic viscosity of the lubricant diluted by the refrigerant is recovered.

In the aspect, the chiller may further include a discharge pipe that discharges the lubricant and the refrigerant from the second housing to the oil tank, and a heater that is disposed inside the discharge pipe located inside the oil tank.

According to this configuration, the lubricant and the refrigerant are discharged from the second housing to the oil tank via the discharge pipe. The discharge pipe is also located inside the oil tank. The heater is installed in the discharge pipe located inside the oil tank. The temperature of the heater is raised. In this manner, the lubricant and the refrigerant are heated, and the refrigerant evaporates. As a result, the kinematic viscosity of the lubricant diluted by the refrigerant is recovered.

### Advantageous Effects of Invention

According to the present invention, a simple configuration can cool the lubricant to be supplied to components of a turbo compressor.

### BRIEF DESCRIPTION OF DRAWINGS

FIG. 1 is a configuration diagram illustrating a centrifugal chiller according to an embodiment of the present invention.

FIG. 2 is a longitudinal sectional view illustrating a turbo compressor of the centrifugal chiller according to the embodiment of the present invention.

FIG. 3 is a longitudinal sectional view illustrating an oil tank of the centrifugal chiller according to the embodiment of the present invention.

### DESCRIPTION OF EMBODIMENTS

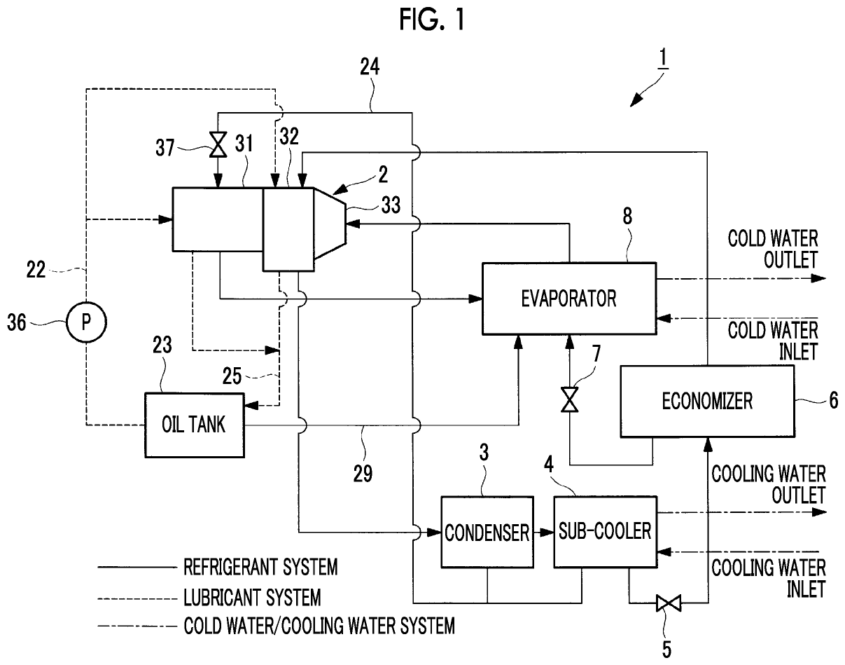

Hereinafter, a centrifugal chiller 1 according to an embodiment of the present invention will be described with reference to the drawings. As illustrated in FIG. 1, the centrifugal chiller 1 includes a turbo compressor 2 that compresses a refrigerant, a condenser 3 that cools and condenses the refrigerant, a sub-cooler 4 that provides the refrigerant with a supercooling degree by re-cooling cools a liquid refrigerant condensed in the condenser 3, a first pressure-reducing valve 5 that reduces a pressure of a high-pressure refrigerant to an intermediate pressure, an economizer 6 that provides the refrigerant with the supercooling degree, a second pressure-reducing valve 7 that reduces a pressure of the refrigerant to a low pressure, and an evaporator 8 that causes a low-pressure refrigerant to evaporate.

The turbo compressor 2, the condenser 3, the sub-cooler 4, the first pressure-reducing valve 5, the economizer 6, the second pressure-reducing valve 7, and the evaporator 8 configure a refrigeration cycle. The refrigerant sequentially circulates in the turbo compressor 2, the condenser 3, the sub-cooler 4, the first pressure-reducing valve 5, the economizer 6, the second pressure-reducing valve 7, and the evaporator 8 in this order. In addition, the refrigerant is supplied from the economizer 6 to the turbo compressor 2.

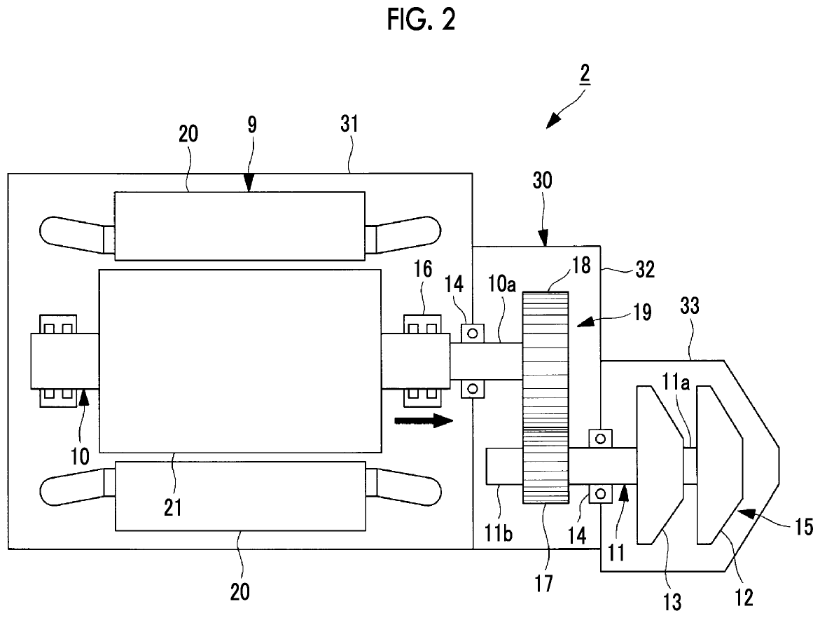

As illustrated in FIG. 2, the turbo compressor 2 includes a housing 30 configured so that a motor housing 31, an accelerator housing 32, and a compressor housing 33 are integrally coupled with each other. A motor 9 driven at variable speed by an inverter device is incorporated in the motor housing 31. One end 10a of a motor shaft 10 of the motor 9 protrudes from the motor housing 31 to the accelerator housing 32. The motor 9 includes a stator 20 and a rotor 21. The rotor 21 is fixed to the motor shaft 10, and the rotor 21 is rotated inside the stator 20. The motor shaft 10 is supported by a rolling bearing 14 on the accelerator housing 32 side. For example, the rolling bearing 14 has a plurality of angular ball bearings. The rolling bearing 14 is installed in the motor housing 31 via a bearing housing (not illustrated).

The compressor housing 33 internally houses a compression mechanism 15 having a first stage compression stage and a second stage compression stage. The refrigerant suctioned into the first stage compression stage from the outside and compressed by the first stage compression stage is fed to the second stage compression stage. Then, the refrigerant suctioned into the second stage compression stage and compressed by the second stage compression stage is discharged outward.

A rotary shaft 11 is rotatably installed inside the compressor housing 33. A first stage impeller 12 for a first stage compression stage and a second stage impeller for a second stage compression stage are disposed on one end 11a side of the rotary shaft 11. The rotary shaft is supported by the rolling bearing 14 on the accelerator housing 32 side. For example, the rolling bearing 14 has a plurality of angular ball bearings. The rolling bearing 14 is installed in the compressor housing 33 via a bearing housing (not illustrated).

A small diameter gear 17 is disposed on the other end 11b side of the rotary shaft 11 supported by the rolling bearing 14. The gear 17 meshes with a large diameter gear 18 disposed in one end 10a of the motor shaft 10, and the speed-increasing mechanism 19 is configured to include the gears 17 and 18. The speed-increasing mechanism 19 is housed in the accelerator housing 32.

The lubricant is supplied to each component of the rolling bearing 14 or the gears 17 and 18.

The lubricant supply line 22 is a pipe connecting the oil tank 23 and the turbo compressor 2 to each other. The lubricant is supplied from the oil tank 23 to the motor housing 31 or the accelerator housing 32 of the turbo compressor 2 by the oil pump 36 disposed in the lubricant supply line 22. The lubricant passing through the rolling bearing 14 and the speed-increasing mechanism 19 returns to the oil tank 23 via the lubricant discharge line 25. Unlike the related art, an oil cooler is not installed in the lubricant supply line 22 or the lubricant discharge line 25 according to the present embodiment.

The motor housing 31 or the accelerator housing 32 has a lubricant inlet connected to the lubricant supply line 22, and the lubricant is supplied from the lubricant supply line 22 to the turbo compressor 2.

The liquid refrigerant extracted from the condenser 3 or the sub-cooler 4 configuring the refrigeration cycle is supplied to the turbo compressor 2. The motor housing 31 has a liquid refrigerant inlet connected to the liquid lubricant supply line 24, and the liquid refrigerant is supplied to the motor housing 31 from the liquid lubricant supply line 24. The liquid lubricant supply line 24 has an expansion valve 37. When the liquid refrigerant passes through the expansion valve 37, the temperature of the liquid refrigerant is lowered.

Then, the liquid refrigerant extracted from the condenser 3 or the sub-cooler 4 bypasses the lubricant system inside the motor housing 31 or inside the accelerator housing 32 of the turbo compressor 2, and is subjected to heat exchange. In this manner, inside the motor housing 31 or inside the accelerator housing 32 of the turbo compressor 2, the lubricant passing through the gears 17 and 18 or the rolling bearing 14 inside the motor housing 31 or inside the accelerator housing 32 of the turbo compressor 2 is cooled by the liquid refrigerant extracted from the condenser 3 or the sub-cooler 4.

The liquid refrigerant supplied from the condenser 3 or the sub-cooler 4 flows from the motor 9 side to the rolling bearing 14 side due to a differential pressure inside the motor housing 31 or inside the accelerator housing 32. In this case, a labyrinth seal 16 and the motor shaft 10 are configured so that the liquid refrigerant passes through the labyrinth seal 16. In this manner, the lubricant is cooled by the liquid refrigerator in the motor housing 31 or the accelerator housing 32.

The refrigerant used in cooling the lubricant inside the motor housing 31 or inside the accelerator housing 32 of the turbo compressor 2, and the cooled lubricant are discharged to the oil tank 23. The motor housing 31 or the accelerator housing 32 has a lubricant outlet connected to the lubricant discharge line 25. The refrigerant and the lubricant are discharged from the motor housing 31 or the accelerator housing 32 to the oil tank 23 via the lubricant discharge line 25.

The lubricant discharged to the oil tank 23 is diluted by the liquid refrigerant. Means for causing the liquid refrigerant to evaporate in order to increase concentration of the diluted lubricant is installed in the oil tank 23. Since the liquid refrigerant evaporates, the kinematic viscosity of the lubricant recovers a state before the liquid refrigerant is diluted, and the liquid lubricant can be repeatedly used as the lubricant for lubricating the gears 17 and 18 or the rolling bearing 14.

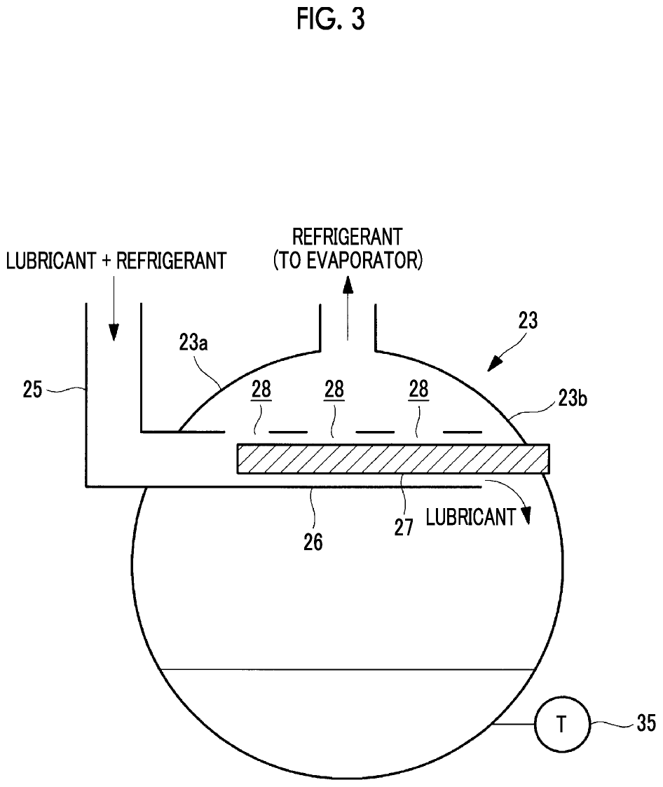

As illustrated in FIG. 3, the oil tank 23 is a container which can contain the lubricant, and the lubricant is stored in a lower portion inside oil tank 23. The oil tank 23 has a lubricant/refrigerant inlet connected to the lubricant discharge line 25, and a pipe 26 of the lubricant discharge line 25 is installed while extending into the oil tank 23. For example, the pipe 26 of the lubricant discharge line 25 installed inside the oil tank 23 is located from a side wall 23a of the oil tank 23 having the lubricant/refrigerant inlet toward a side wall 23b facing the side wall 23a.

A heater insertion port is formed on the side wall 23b facing the side wall 23a of the oil tank 23 having the lubricant/refrigerant inlet. A heater 27 is installed in the pipe 26 of the lubricant discharge line 25 installed inside the oil tank 23. The heater 27 is inserted into the pipe 26 from the outside of the oil tank 23 via the heater insertion port.

The heater 27 heats the liquid refrigerant and the lubricant which flow through the lubricant discharge line so that the liquid refrigerant evaporates. In this manner, refrigerant gas generated by the evaporation is directed upward of the oil tank 23, and the lubricant from which the refrigerant evaporates and having a reduced content of the refrigerant falls downward of the oil tank from an end portion of the pipe 26. A plurality of holes 28 may be formed on an upper surface of the pipe 26 of the lubricant discharge line 25 installed inside the oil tank 23. In this manner, the evaporated refrigerant is likely to be directed upward of the oil tank 23 after passing through the holes 28. Accordingly, the lubricant or the heated and evaporated refrigerant is less likely to stay inside the pipe 26.

A lubricant outlet connected to the lubricant supply line 22 is formed below the oil tank 23, and the lubricant is supplied from the oil tank 23 to the turbo compressor 2 via the lubricant supply line 22. In addition, a refrigerant gas outlet connected to the refrigerant gas supply line 29 is formed above the oil tank 23, and the refrigerant gas is supplied from the oil tank 23 to the evaporator 8 via the refrigerant gas supply line 29. In this manner, the refrigerant supplied from the condenser or the sub-cooler 4 to the turbo compressor 2 returns to the refrigeration cycle.

Preferably, the lubricant stored inside the oil tank is adjusted so as to maintain a predetermined temperature range. For example, the temperature of the lubricant is determined, based on the temperature which properly lubricating the gears 17 and 18 or the rolling bearing 14 of the turbo compressor 2 lubricated by the lubricant.

For example, the temperature of the lubricant stored inside the oil tank 23 is adjusted by the heating of the heater 27. The heating of the heater 27 is controlled, based on the temperature measured by the temperature measuring unit 35 installed in a lower portion of the oil tank 23. The heater 27 may be controlled to be turned on and off, based on the measured temperature, and the heating for the liquid refrigerant or the lubricant may be adjusted. Alternatively, the set temperature of the heater 27 may be adjusted, based on the measured temperature.

Next, a supply method and a cooling method of the lubricant in the centrifugal chiller 1, according to the present embodiment will be described.

The lubricant is stored in the oil tank 23, and is supplied from the oil tank 23 to the turbo compressor 2 by the oil pump 36. The lubricant supplied to the turbo compressor 2 is supplied to the gears 17 and 18 or the rolling bearing 14 inside the motor housing 31 or inside the accelerator housing 32 of the turbo compressor 2.

While the lubricant supplied to the gears 17 and 18 or the rolling bearing 14 lubricates the gears 17 and 18 or the rolling bearing 14, the temperature of the lubricant is raised due to a friction loss.

The liquid refrigerant extracted from the condenser 3 or the sub-cooler 4 configuring the refrigeration cycle is supplied to the centrifugal chiller 1 so as to cool the lubricant. Then, the lubricant inside the motor housing or inside the accelerator housing 32 of the turbo compressor 2 is subjected to heat exchange with the liquid refrigerant extracted from the condenser 3 or the sub-cooler 4. In this manner, the lubricant passing through the gears 17 and 18 or the rolling bearing 14 inside the motor housing 31 or inside the accelerator housing 32 of the turbo compressor 2 is cooled by the liquid refrigerant extracted from the condenser 3 or the sub-cooler 4.

Thereafter, the refrigerant used in cooling the lubricant inside the motor housing 31 or inside the accelerator housing 32 of the turbo compressor 2, and the cooled lubricant are discharged to the oil tank 23.

The lubricant and the liquid refrigerant which are discharged to the oil tank 23 are heated by the heater 27 installed in the pipe 26 of the lubricant discharge line inside the oil tank 23, thereby causing the liquid refrigerant to evaporate. As a result, the kinematic viscosity of the lubricant diluted by the liquid refrigerant is recovered.

The lubricant from which the liquid refrigerant evaporates and having the reduced content of the liquid refrigerant is stored in the lower portion of the oil tank 23. In addition, the refrigerant gas evaporated by the heater 27 is directed upward of the oil tank 23, and the refrigerant gas is supplied from the oil tank 23 to the evaporator 8 via the refrigerant gas supply line 29. In this manner, the refrigerant supplied from the condenser 3 or the sub-cooler 4 to the turbo compressor 2 returns to the refrigeration cycle.

As described above, according to the present embodiment, the liquid refrigerant extracted from the refrigeration cycle is supplied to the motor housing 31 or the accelerator housing 32. The lubricant used in cooling the gears 17 and 18 or the rolling bearing 14 in the motor housing 31 or the accelerator housing 32 is cooled by the liquid refrigerant. Therefore, the lubricant can be cooled without using the oil cooler used in the related art, and it is not necessary to install the oil cooler. As a result, according to the present embodiment, the cost required for equipment installation can be reduced. In addition, the lubricant diluted by the liquid refrigerant in the motor housing 31 or the accelerator housing 32 can be repeatedly used as the lubricant, since the kinematic viscosity is recovered after the liquid refrigerant is caused to evaporate by the heater 27 disposed in the oil tank 23. Furthermore, based on the temperature of the lubricant stored in the oil tank 23, the temperature control of the heater 27 is adjusted. The lubricant stored in the oil tank 23 is adjusted to have the temperature which can properly lubricate the gears 17 and 18 or the rolling bearing 14.

### REFERENCE SIGNS LIST

1: centrifugal chiller

2: turbo compressor

3: condenser

4: sub-cooler

5: first pressure-reducing valve

6: economizer

7: second pressure-reducing valve

8: evaporator

9: motor

10: motor shaft

11: rotary shaft

12: first stage impeller

13: second stage impeller

14: rolling bearing

15: compression mechanism

16: labyrinth seal

17: gear

18: gear

19: speed-increasing mechanism

20: stator

21: rotor

22: lubricant supply line

23: oil tank

24: liquid lubricant supply line

25: lubricant discharge line

26: pipe

27: heater

28: hole

29: refrigerant gas supply line

30: housing

31: motor housing

32: accelerator housing

33: compressor housing

35: temperature measuring unit

36: oil pump

37: expansion valve

1-6. (canceled)

7. A chiller comprising:
a refrigeration cycle that includes an electric compressor having a compression mechanism driven by a motor, a condenser, and an evaporator, and that allows a refrigerant to circulate therethrough;
an oil tank that stores a lubricant;
an oil supply pipe that supplies the lubricant from the oil tank into a first housing which houses the motor; and
a refrigerant supply pipe that supplies the refrigerant from the condenser into the first housing,
wherein an expansion valve is disposed in the refrigerant supply pipe, and the refrigerant passing through the expansion valve is supplied into the first housing.

8. The chiller according to claim 7,
wherein the electric compressor further has a speed-increasing mechanism coupled with the motor and the compression mechanism, and
wherein the refrigerant and the lubricant flow from the first housing, and flow from the oil tank into a second housing which houses the speed-increasing mechanism.

9. The chiller according to claim 7,
wherein the electric compressor further has a speed-increasing mechanism coupled with the motor and the compression mechanism, and
wherein the oil supply pipe supplies the lubricant from the oil tank into a second housing which houses the speed-increasing mechanism.

10. The chiller according to claim 7,
wherein the refrigeration cycle further includes a sub-cooler, and
wherein the refrigerant supply pipe supplies the refrigerant from the sub-cooler into the first housing.

11. The chiller according to claim 7, further comprising:
a discharge pipe that discharges the lubricant and the refrigerant from the first housing to the oil tank; and
a heater that is disposed inside the discharge pipe located inside the oil tank.

12. The chiller according to claim 8, further comprising:
a discharge pipe that discharges the lubricant and the refrigerant from the second housing to the oil tank; and
a heater that is disposed inside the discharge pipe located inside the oil tank.

13. The chiller according to claim 9, further comprising:
a discharge pipe that discharges the lubricant and the refrigerant from the second housing to the oil tank; and
a heater that is disposed inside the discharge pipe located inside the oil tank.
